(19) United States
(12) Patent Application Publication
(10) Pub. No.: US 2026/0317661 A1
(43) Pub. Date: Oct. 15, 2026

(54) CLEANING ARTICLES HAVING A COATING, METHODS OF MAKING SAME, AND KITS

(71) Applicant: 3M INNOVATIVE PROPERTIES COMPANY, St. Paul, MN (US)

(72) Inventors: Chunjie Zhang, Shoreview, MN (US); Yifan Zhang, Woodbury, MN (US); Kyle C. Bryson, Maplewood, MN (US); Siwei Leng, Woodbury, MN (US); Matthew D. Chaffee, Minneapolis, MN (US)

(21) Appl. No.: 19/101,308

(22) PCT Filed: Jul. 31, 2023
(86) PCT No.: PCT/IB2023/057765

§ 371 Date: Feb. 5, 2025

Related U.S. Application Data
(60) Provisional application No. 63/403,928, filed on Sep. 6, 2022.

(51) Int. Cl. C11D 17/00; A47K 11/10; B24B 27/033; C11D 3/00; C11D 3/04; C11D 3/10; C11D 3/12; C11D 3/20; C11D 3/37; C11D 3/50; C11D 11/00; E03D 9/00

(52) U.S. Cl. CPC C11D 17/0082; B24B 27/033; C11D 3/0052; C11D 3/042; C11D 3/10; C11D 3/122; C11D 3/2086; C11D 3/3707; C11D 3/505; C11D 11/0082; C11D 17/0056; A47K 11/10; E03D 9/00

(57) ABSTRACT

The present disclosure provides a cleaning article. The cleaning article includes a compressed composition having an exterior surface, where the compressed composition includes a gas generator, an acid, a surfactant, and a binder. The cleaning article further includes a solid coating disposed on at least a portion of the exterior surface of the compressed composition, where the solid coating includes a polyethylene oxide carrier and at least one functional ingredient. The cleaning article may be made by obtaining a molten mixture of a polyethylene oxide carrier and at least one functional ingredient; applying the molten mixture to at least a portion of an exterior surface of a compressed composition; and cooling the applied molten mixture to form a solid coating. Kits are also provided, including a cleaning article and a tool configured to attach to the cleaning article.

### FIELD OF THE INVENTION

The present invention relates generally to the field of cleaning compositions, such as bathroom cleaning composition.

### BACKGROUND

Cleaning a bathroom is an undesirable but necessary task. Various products have been developed for cleaning the bathroom (e.g., toilet, sink, bathtub, shower, etc.). Further developments in cleaning articles would be desirable.

### SUMMARY

In a first aspect, a cleaning article is provided. The cleaning article includes a compressed composition having an exterior surface, where the compressed composition includes a gas generator, an acid, a surfactant, and a binder. The cleaning article further includes a solid coating disposed on at least a portion of the exterior surface of the compressed composition, where the solid coating includes a polyethylene oxide carrier and at least one functional ingredient.

In a second aspect, a method of making a cleaning article is provided. The method includes obtaining a molten mixture of a polyethylene oxide carrier and at least one functional ingredient; applying the molten mixture to at least a portion of an exterior surface of a compressed composition; and cooling the applied molten mixture to form a solid coating.

In a third aspect, a kit is provided. The kit includes a cleaning article according to the first aspect and a tool configured to attach to the cleaning article.

At least certain embodiments of these aspects advantageously provide a cleaning article that includes active ingredient(s) in a water-soluble coating, thereby expanding the types of functional ingredients that can be incorporated into cleaning articles. Such cleaning articles may be used alone and/or with a tool to manipulate the cleaning article.

The above summary of the present disclosure is not intended to describe each disclosed embodiment or every implementation of the present disclosure. The description that follows more particularly exemplifies illustrative embodiments. In several places throughout the application, guidance is provided through lists of examples, which examples can be used in various combinations. In each instance, the recited list serves only as a representative group and should not be interpreted as an exclusive list.

### BRIEF DESCRIPTION OF THE DRAWINGS

FIG. 1A is a schematic cross-sectional view of an exemplary cleaning article.

FIG. 1B is a schematic cross-section view of another exemplary cleaning article.

FIGS. 2A-2B are photographs of the exemplary cleaning article of Example 1.

FIG. 3 is a schematic perspective view of compressed composition having a cavity in one major surface.

FIGS. 4A-4B are photographs of the exemplary cleaning article of Example 3.

FIG. 5A is a photograph of one view of the exemplary cleaning article of Example 4.

FIG. 5B is a photograph of one view of the uncoated tablet of Example 4.

FIG. 5C is a photograph of an opposite view of the exemplary cleaning article of Example 4.

FIG. 5D is a photograph of an opposite view of the uncoated tablet of Example 4.

FIG. 6 is a generalized flow chart of an exemplary method.

FIG. 7A is a schematic perspective view of an exemplary kit in use for cleaning a toilet.

FIG. 7B is a schematic perspective view of an exemplary cleaning article being dropped in a toilet for use in cleaning.

While the above-identified figures set forth several embodiments of the disclosure other embodiments are also contemplated, as noted in the description. The figures are not necessarily drawn to scale. In all cases, this disclosure presents aspects of the invention by way of representation and not limitation.

### DETAILED DESCRIPTION

### Glossary

As used herein, “exterior surface” refers to an outermost surface.

As used herein, “solid” refers to a solid state of matter, as opposed to a liquid state of matter or gaseous state of matter.

As used herein, “molten” refers to a mixture that flows freely but is of constant volume due to being at a temperature above its melting point.

As used herein, “polyethylene oxide carrier” encompasses polyethylene oxide (PEO) homopolymers, PEO copolymers that are greater than 50% by mass of PEO, and PEO derivatives. Each of the aforementioned PEO components may independently be linear or branched.

The words “preferred” and “preferably” refer to embodiments of the disclosure that may afford certain benefits, under certain circumstances. However, other embodiments may also be preferred, under the same or other circumstances. Furthermore, the recitation of one or more preferred embodiments does not imply that other embodiments are not useful and is not intended to exclude other embodiments from the scope of the disclosure.

In this application, terms such as “a”, “an”, and “the” are not intended to refer to only a singular entity, but include the general class of which a specific example may be used for illustration. The terms “a”, “an”, and “the” are used interchangeably with the term “at least one.” The phrases “at least one of” and “comprises at least one of” followed by a list refers to any one of the items in the list and any combination of two or more items in the list.

As used herein, the term “or” is generally employed in its usual sense including “and/or” unless the content clearly dictates otherwise. The term “and/or” means one or all of the listed elements or a combination of any two or more of the listed elements.

Also herein, all numbers are assumed to be modified by the term “about” and preferably by the term “exactly.” As used herein in connection with a measured quantity, the term “about” refers to that variation in the measured quantity as would be expected by the skilled artisan making the measurement and exercising a level of care commensurate with the objective of the measurement and the precision of the measuring equipment used.

As used herein as a modifier to a property or attribute, the term “generally”, unless otherwise specifically defined, means that the property or attribute would be readily recognizable by a person of ordinary skill but without requiring absolute precision or a perfect match (e.g., within +/−20% for quantifiable properties). The term “substantially”, unless otherwise specifically defined, means to a high degree of approximation (e.g., within +/−10% for quantifiable properties) but again without requiring absolute precision or a perfect match. Terms such as same, equal, uniform, constant, strictly, and the like, are understood to be within the usual tolerances or measuring error applicable to the particular circumstance rather than requiring absolute precision or a perfect match.

Various active ingredients may be favored by consumers for inclusion in cleaning compositions, yet such ingredients may not be compatible with other ingredients and/or with the form factor of the composition (e.g., a compressed tablet). For instance, the manufacturing process of making solid-state effervescent articles, e.g., compressing, puts a limit on the feasible spectrum of the composition of such tablets. This is because the composition is typically optimized to provide acceptable flowability of a powder mixture and clean release from a mold during tablet making, plus to result in sufficient mechanical integrity of the finished tablets. As such, any presence (or a high loading) of some functional ingredients becomes a challenge, especially those that cause at least one of manufacturing issues, or compromise mechanical properties or aging stabilities of tablets. It has unexpectedly been discovered that one or more functional ingredients can be included in a cleaning article by incorporating the active ingredient(s) in a coating that is applied to an exterior surface of a compressed tablet.

### Cleaning Articles

In a first aspect, a cleaning article is provided. The cleaning article comprises:
a compressed composition comprising an exterior surface, the compressed composition comprising a gas generator, an acid, a surfactant, and a binder; and
a solid coating disposed on at least a portion of the exterior surface of the compressed composition, the solid coating comprising a polyethylene oxide carrier and at least one functional ingredient.

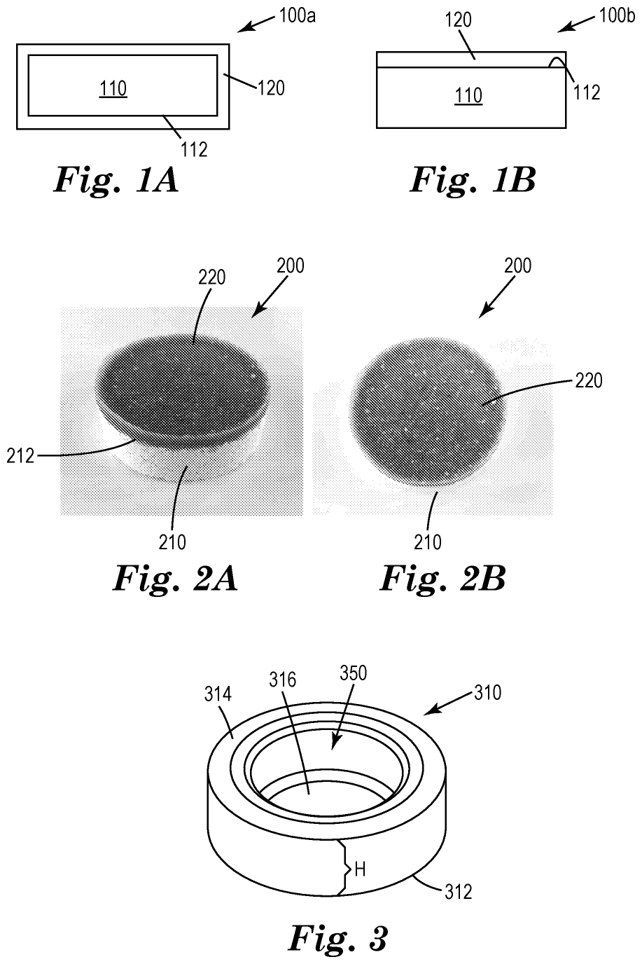

Referring to FIG. 1A, a schematic cross-sectional view is provided of an exemplary cleaning article 100a, which comprises a compressed composition 110 and a solid coating 120 disposed on at least a portion of the exterior surface 112 of the compressed composition 110. In this particular embodiment, the solid coating 120 is present on at least four surfaces of the compressed composition 110.

Referring to FIG. 1B, a schematic cross-sectional view is provided of an exemplary cleaning article 100b, which comprises a compressed composition 110 and a solid coating 120 disposed on at least a portion of the exterior surface 112 of the compressed composition 110. In this particular embodiment, the solid coating 120 is present on at least one major surface of the compressed composition 110. Similar to the exemplary cleaning article 100b of FIG. 1B, photographs of the exemplary cleaning article 200 of Example 1 (described in detail below) are provided in FIGS. 2A-2B. It can be seen that a solid coating 220 is disposed on a major exterior surface 212 of a compressed composition 210 (e.g., present on a top surface, based on the orientation of the cleaning article 200 in the photograph).

It is expressly contemplated that a solid coating may be present in any convenient amount or pattern on one or more exterior surfaces of a compressed composition. For instance, the solid coating in some cases is present on 5% or greater of a total area of the exterior of the compressed composition, 10%, 15%, 20%, 25%, 30%, 35%, 40%, 45%, or 50% or greater; and 100% or less, 95%, 90%, 85%, 80%, 75%, 70%, 65%, 60%, or 55% or less of total area of the exterior of the compressed composition. The solid coating may be disposed in either a continuous or discontinuous pattern on the compressed composition.

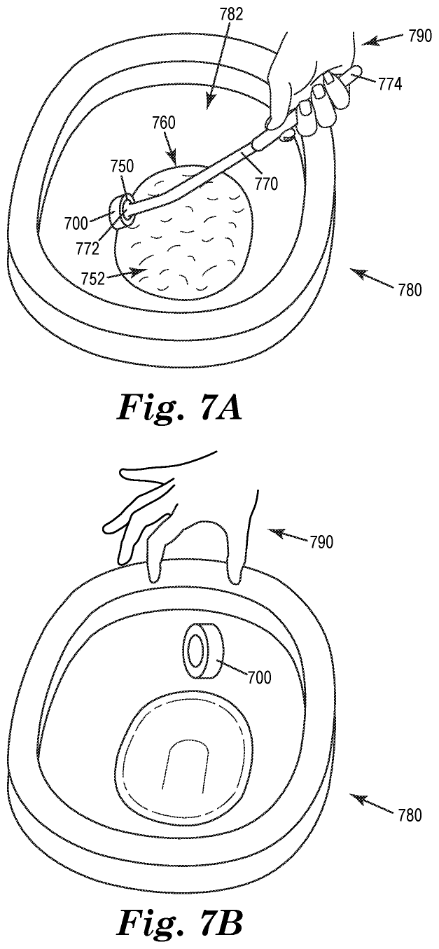

In certain embodiments, the compressed composition is in a form of a tablet having a first major surface and a second major surface, in which a portion of the second major surface defines a cavity in the tablet. For instance, referring to FIG. 3, the compressed composition 310 includes a first major surface 312 and an opposing second major surface 314. The second major surface 314 defines a cavity 350, leaving the second major surface 314 to provide a rim to the tablet. Such a configuration may be advantageous when a cleaning article is to be used with a tool that is configured to engage the compressed composition. For instance, a portion of a tool may be configured to grip, and/or be inserted into, the cavity 350 (e.g., as shown in FIG. 7A).

The cleaning article can gradually dissolve in the presence of water, providing effervescence, foaming, acidity, and optionally additional properties (e.g., abrasiveness) to enable effective cleaning. In one embodiment, the cleaning article is used to clean and/or remove stains such as hard water stains from toilet bowls.

### Compressed Composition

Suitable compositions that can be used for making compressed cleaning articles are described herein. The composition provides effervescence, foaming, and acidity after being dissolved in water. In addition, the composition can be compressed into a solid article at low temperatures. Typically, such compositions have good stability at both room temperature and elevated temperatures. The composition is dissolvable in water and leaves minimal residue after cleaning. At least certain embodiments of the composition can be tuned to specifically allow enhanced oxidizing power, acidity, or effervescence as needed by product development needs. The composition can be molded under pressure at room temperature into a compressed composition.

As noted above, the composition includes each of a gas generator, an acid, a surfactant, and a binder.

The gas generator functions as an effervescent agent to create foam/bubbles. By producing foam and/or bubbles, the composition is capable of reaching additional surface area. Examples of suitable gas generators include, but are not limited to: carbon dioxide generators and oxygen generators. Examples of suitable carbon dioxide generators include, but are not limited to: bicarbonate salts of Group I metals, of Group II metals and of other cations, including ammonium, alkyl (mono-, di-, or tri-) ammonium, or those of transition metals; carbonate salts of Group I metals, of Group II metals, and of other cations, including ammonium, alkyl (mono-, di-, or tri-) ammonium, or those of transition metals; and percarbonate salts of Group I metals, of Group II metals, and of other cations, including ammonium, alkyl (mono-, di-, or tri-) ammonium, or those of transition metals. Examples of particularly suitable carbon dioxide generators include, but are not limited to: sodium carbonate, sodium bicarbonate, potassium carbonate, potassium bicarbonate, and magnesium carbonate.

Examples of suitable oxygen generators include, but are not limited to: hydrogen peroxide; peracetic acid generated from sodium percarbonate/TAED (tetraacetylethylenediamine); percarbonate salts of Group I metals, of Group II metals and of other cations, including ammonium, alkyl (mono-, di-, or tri-) ammonium, or those of transition metals; chlorate and perchlorate salts of Group I metals, of Group II metals and of other cations, including ammonium, alkyl (mono-, di-, or tri-) ammonium, or those of transition metals; superoxide salts of Group I metals, of Group II metals and of other cations, including ammonium, alkyl (mono-, di-, or tri-) ammonium, or those of transition metals; and peroxide salts of Group I metals, of Group II metals and of other cations, including ammonium, alkyl (mono-, di-, or tri-) ammonium, or those of transition metals.

Suitable amounts for the presence of one or more gas generators are typically 10 wt. % or greater based on a total weight of the compressed composition, 11 wt. %, 12 wt. %, 13 wt. %, 14 wt. %, 15 wt. %, 16 wt. %, 17 wt. %, 18 wt. %, 19 wt. %, or 20 wt. % or greater; and 50 wt. % or less, 45 wt. %, 40 wt. %, 35 wt. %, 30 wt. %, or 25 wt. % or less, based on a total weight of the compressed composition.

The acid functions as both an effervescent agent and a cleaning agent. The acid can be any solid form organic or inorganic acid. Examples of suitable acids include, but are not limited to: sodium bisulfate, sulfamic acid, glycolic acid, maleic acid, benzoic acid, and/or succinic acid.

Suitable amounts for the presence of one or more acids are typically 15 wt. % or greater based on a total weight of the compressed composition, 16 wt. %, 17 wt. %, 18 wt. %, 20 wt. %, 22 wt. %, 24 wt. %, 26 wt. %, 28 wt. %, or 30 wt. % or greater; and 70 wt. % or less, 65 wt. %, 60 wt. %, 55 wt. %, 50 wt. %, 45 wt. %, 35 wt. %, 30 wt. %, or 25 wt. % or less, based on a total weight of the compressed composition.

At least one surfactant is included and is used as a cleaning and foaming agent. Examples of suitable surfactants include, but are not limited to: anionic surfactants, nonionic surfactants, cationic surfactants, zwitteronic surfactants, amphoteric surfactants, oligomeric and polymeric surfactants. Examples of suitable anionic surfactants include, but are not limited to: alkyl and alkyl ether sulfates, sulfated monoglycerides, sulfonated olefins, alkyl aryl sulfonates, primary or secondary alkane sulfonates, alkyl sulfosuccinates, acid taurates, alkyl sulfoacetates, acid isethionates, alkyl glycerylether sulfonate, sulfonated methyl esters, sulfonated fatty acids, alkyl phosphates, acyl glutamates, acyl sarcosinates, alkyl lactylates, anionic fluorosurfactants, sodium lauroyl glutamate, and combinations thereof. Additional suitable anionic surfactants include those disclosed in U.S. Patent Application No. 61/120,765 and those surfactants disclosed in McCutcheon's Detergents and Emulsifiers, North American Edition (1992), Allured Publishing Corp. Examples of suitable nonionic surfactants include, but are not limited to: polyoxyethylenated alkyl phenols, polyoxyethylenated alcohols, polyoxyethylenated polyoxypropylene glycols, glyceryl esters of alkanoic acids, polyglyceryl esters of alkanoic acids, propylene glycol esters of alkanoic acids, sorbitol esters of alkanoic acids, polyoxyethylenated sorbitor esters of alkanoic acids, polyoxyethylene glycol esters of alkanoic acids, polyoxyethylenated alkanoic acids, alkanolamides, N-alkylpyrrolidones, alkyl glycosides, alkyl polyglucosides, alkylamine oxides, and polyoxyethylenated silicones. Examples of suitable cationic surfactants include, but are not limited to, those selected from the “quaternary ammonium” class of materials including but not limited to; cetyltrimethylammonium chloride, behenyltrimethylammonium chloride, stearyltrimethylammonium chloride, cetylpyridinium chloride, octadecyltrimethylammonium chloride, hexadecyltrimethylammonium chloride, octyldimethylbenzylammonium chloride, decyldimethylbenzylammonium chloride, stearyldimethylbenzylammonium chloride, didodecyldimethylammonium chloride, dioctadecyldimethylammonium chloride, distearyldimethylammonium chloride, tallowtrimethylammonium chloride, cocotrimethylammonium chloride, dipalmitoylethyldimethylammonium chloride, PEG-2 oleylammonium chloride, and salts of these, where the chloride is replaced by halogen, (e.g., bromide), acetate, citrate, lactate, glycolate, phosphate nitrate, sulphate, or alkylsulphate. Examples of suitable zwitteronic and amphoteric surfactants include, but are not limited to: amine oxides, betaines (carboxylic acid/quaternary ammonium or carboxylic acid/phosphonium), sulfobetaines, or carboxybetaines, sultaines (sulfonic acid/quaternary ammonium or sulfonic acid/phosphonium), amino acid derivatives, imidazoline derivatives, lecithins, and phospholipids. Examples of suitable polymeric surfactants include, but are not limited to: block copolymers of ethylene oxide and fatty alkyl residues, block copolymers of ethylene oxide and propylene oxide, hydrophobically modified polyacrylates, hydrophobically modified celluloses, silicone polyethers, silicone copolyol esters, diquaternary polydimethylsiloxanes, and co-modified amino/polyether silicones.

Suitable amounts for the presence of one or more surfactants are typically 0.5 wt. % or greater based on a total weight of the compressed composition, 0.75 wt. %, 1 wt. %, 1.25 wt. %, 1.5 wt. %, 1.75 wt. %, 2 wt. %, 2.5 wt. %, 3 wt. %, 3.5 wt. %, 4 wt. %, 4.5 wt. %, or 5 wt. % or greater; and 10 wt. % or less, 9.5 wt. %, 9 wt. %, 8.5 wt. %, 8 wt. %, 7.5 wt. %, 7 wt. %, 6.5 wt. %, 6 wt. %, 5.5 wt. %, or 5 wt. % or less, based on a total weight of the compressed composition.

The binder functions to maintain the components of the composition together. The binder must be strong enough to hold the mechanical integrity and optionally also to provide hardness to the composition until the composition comes into contact with water, at which time it can dissolve. The binder can chemically or physically hold together the components of the composition, forming covalent bonds, ionic bonds, hydrogen bonds, Van der Waals interactions, or other secondary interactions, for instance in the presence of a water-containing liquid. The binder can be inorganic or organic, or a combination of both. The binder can be chemically reactive or unreactive during the binding process.

In one embodiment, the binder is an inorganic binder that reacts with water to cause the composition to harden. To harden means that the binder reacts with water to form a new hydrated form or the binder condenses and crosslinks in the presence of water. The hardened binder provides structural support to the composition and makes it resistant to deterioration caused by water. During the hardening process, the binder can form hydrogen bonding with other components, improving the structural integrity of the composition. Compared to an unreactive binder, the use of an inorganic binder that is reactive with water can significantly improve the hardness and mechanical integrity of the composition after the composition is compressed at room temperature under the same amount of force.

In some embodiments, after forming a compressed article, the composition containing the reactive inorganic binder can maintain enough hardness, mechanical integrity, and durability for scrubbing and cleaning with minimal swelling of the formed geometry, for example, when in contact with water inside a toilet bowl. It is the strong bonding ability of the reactive inorganic binder that enables the durability of the compressed article when used in water or in a wet environment. The durability of the compressed article in a wet state can be quantified by the number of cycles that the compressed article can move back and forth linearly with a selected path length (5 cm, 10 cm, 20 cm) and speed, or selected number of cycles on a circular path and speed, under certain applied weight (0.5 kg, 1.0 kg, 2.0 kg, 5 kg, 10 kg) in wet state, on a suitable machine, for example, a Taber Linear Abraser or Taber Rotary Platform Abrasion Tester (North Tonawanda, NY). The wet state means the compressed article is immersed in water, and then taken out, or stays immersed in water, during testing. To simulate the use of the compressed article in water or in a wet environment, the compressed article with a cylindrical geometry (diameter of 4 cm, height of 0.25 cm, 0.38 cm, 0.50 cm, or 0.56 cm) is first immersed in water to allow complete penetration of water into the compressed article, pressed against a hard surface, then moved back and forth with a path length of about 20 cm held by hand. The compressed article is considered to show sufficient “wet hardness”, that is, sufficient, mechanical integrity, and durability when used in wet state. The compressed article effervesces and foams when rubbed against the hard surface with force applied by hand and gradually loses mass during the simulated cleaning process.

Compressed articles containing unreactive binders will lose their hardness and mechanical integrity or swell when used in water within a short period of time, for example, about 2 minutes. The hardness of the composition can be measured, for example, by compressing a durometer for Shore Hardness A or D on the surface of the composition following procedures described in ASTM D 2240-00. Aged hardness is the hardness measured on a compressed composition aged at room temperature in air for two weeks. Examples of a particularly suitable reactive inorganic binders include, but are not limited to: calcium sulfate hemihydrate, anhydrous calcium sulfate, sodium silicate, sodium metasilicate, potassium silicate, potassium metasilicate, lithium metasilicate, lithium silicate, cement, and combinations thereof. An example of a particularly suitable reactive inorganic binder includes, but is not limited to, formulated binder compositions based on calcium sulfate hemihydrate, such as DURABOND 20, DURABOND 45, and DURABOND 90 available from USG, located in Chicago, IL.

Alternatively, in some embodiments the compressed composition provides a soft soap that does not require the ability to scrub. In such embodiments the above-described wet harness and Shore Hardness values do not need to be met for a compressed composition to be considered useful for cleaning.

Examples of particularly suitable organic binders include, but are not limited to: sugars (such as glucose, fructose, galactose, sucrose, lactose, maltose, and liquid glucose), organic acid salts (such as sodium acetate, calcium acetate, sodium propanoate, sodium glycolate, and sodium citrate), polymers (such as hydroxypropyl cellulose, methyl cellulose, ethyl cellulose, hydroxy propyl methyl cellulose, sodium carboxy methyl cellulose, gelatin, gum arabic chitosan, alginic acid, starch, polyvinylpyrrolidone, polyvinyl alcohol, polyethylene glycol, acrylate polymers, polyurethane, styrene-butadiene rubber, polyester, polyamide, polyethylenimine, vinyl polymer), and combinations thereof.

Suitable amounts for the presence of one or more binders are typically 1 wt. % or greater based on a total weight of the compressed composition, 2 wt. %, 4 wt. %, 6 wt. %, 8 wt. %, 10 wt. %, 12 wt. %, 14 wt. %, 16 wt. %, 18 wt. %, or 20 wt. % or greater; and 50 wt. % or less, 45 wt. %, 40 wt. %, 35 wt. %, 30 wt. %, or 25 wt. % or less, based on a total weight of the compressed composition.

Often, the composition further includes a water-containing liquid. When a water-containing liquid is present, it functions as a reactant with the binder, serves as a medium for other components in the composition to react, as well as serves as the carrier of additives. The reactive inorganic binder can react with water in the water-containing liquid to harden and provide hardness and mechanical integrity to the composition. The water in the water-containing liquid can also serve as the medium for the acid and gas generator to react and generate more water, which creates hydrogen bonding in the composition to improve hardness and mechanical integrity. The water-containing liquid has a water content sufficient to react with the binder. In one embodiment, the water-containing liquid has a water content of at least about 0.1% and particularly at least about 1 wt. %. Examples of suitable water-containing liquids include, but are not limited to: water, aqueous solution of inorganic compounds, aqueous solution of polymers, aqueous dispersion of polymers, aqueous dispersion of organic molecules, liquid organic compounds, mixtures of liquid water and organic compounds, aqueous solutions of organic compounds, and combinations thereof. Examples of suitable liquids include, but not limited to: deionized water, aqueous solution of calcium chloride, aqueous solution of calcium acetate, aqueous solution of sodium acetate, aqueous solution of polyacrylic acid and its sodium salt, aqueous solution of polyvinyl alcohol, aqueous solution of polyvinylpyrrolidone, aqueous solution of polyethylene glycol, aqueous solution of polyethylenimine, aqueous solution of polystyrene sulfonate, aqueous solution of polyester, aqueous dispersion of polyurethane, aqueous dispersion of polyvinyl acetate, aqueous dispersion of styrene butadiene rubber, aqueous dispersion of polyacrylate, aqueous dispersion of polyamide, aqueous dispersion of polyolefin, aqueous dispersion of rosin and its derivatives, mixture of water and acetic acid, mixture of water and lactic acid, aqueous solution of glycolic acid, and aqueous solution of gluconic acid, aqueous dispersion of fragrance, aqueous dispersion of pigment, aqueous solution of dye, and combinations thereof.

Suitable amounts for the presence of one or more water-containing liquids are typically 0.1 wt. % or greater based on a total weight of the compressed composition, 0.5 wt. %, 1 wt. %, 2 wt. %, 3 wt. %, 4 wt. %, 5 wt. %, 6 wt. %, 7 wt. %, 8 wt. %, 9 wt. %, or 10 wt. % or greater; and 20 wt. % or less, 18 wt. %, 16 wt. %, 14 wt. %, 12 wt. %, or 10 wt. % or less, based on a total weight of the compressed composition.

Other additives can be included in the composition to perform various functions. Examples include, but are not limited to: chelating agents, oxidizers, biocides, antimicrobial agents, anti-caking agents, hydrophilic agents, dispersants, co-binders, fillers/tougheners, softeners, abrasive particles, desiccants, mold release agents, lubricants, disintegrants, cleaning agents, coupling agents, photoinitiators, thermal initiators, viscosity modifiers, adhesion promoters, grinding aids, wetting agents, dispersing agents, light stabilizers, antioxidants, anti-foam agents, coloring agents, dyes, pigments, and fragrances. Particularly suitable additives include components which aid in improving the stability of the composition before compression and formation for a compressed article. Examples include anti-caking agents, dispersants, and co-binders. Particularly suitable additives to aid the releasing of the compressed article include, but are not limited to: mold release agents and lubricants.

When a chelating agent is included in the composition, the chelating agent primarily functions as complex forming agents with metal ions dissolved in water or metal ions precipitated on toilet surface as stains. It also promotes cleaning as well as foaming. Examples of suitable chelating agents include, but are not limited to: citric acid and its sodium salts, ethylenediaminetetraacetic acid (EDTA) and its sodium salts, ethylene glycol tetraacetic acid (EGTA) and its sodium salts, and maleic acid and its sodium salts.

When the composition includes an oxidizer, the oxidizer functions to oxidize organic stains and to remove bacteria. Examples of suitable oxidizers include, but are not limited to: sodium persulfate, potassium persulfate, ammonium persulfate, sodium percarbonate, carbamide peroxide, complex of polyvinylpyrrolidone with hydrogen peroxide, sodium perborate, peracetic acid, and combinations thereof. An example of a suitable commercially available oxidizer includes, but is not limited to, Oxone, available from Dupont, located in Wilmington, DE. In one embodiment, when the solid-state composition includes oxidizer, the solid-state composition includes up to about 15 wt. % oxidizer, and particularly up to about 5 wt. % oxidizer.

The composition may optionally include a biocide to remove bacteria. Examples of suitable biocides include, but are not limited to: benzalkonium chloride, sodium dichloroisocyanurate, benzisothiazolinone chlorhexidine chlorhexidine, quaternary ammonium derivatives, and combinations thereof. In one embodiment, when the composition includes a biocide, the solid-state composition includes up to about 5 wt. % biocide, and particularly up to about 2 wt. % biocide.

When the composition includes abrasive particles, such abrasive particles tend to aid in scouring. The abrasive particles are preferably hard enough to sufficiently clean a surface while minimizing any scratching of the surface. In one embodiment, the abrasive particles are sufficiently soft as to not cause scratches on the underlying substrate. In one embodiment, the cleaning article is to be used on bathroom surfaces. Because most surfaces in bathrooms are relatively hard, generally having a Mohs hardness above 4.5, the abrasive particles can be selected from materials having a Mohs hardness of between about 3 and about 4. Examples of suitable abrasive particles include, but are not limited to: crushed or ground shells of nuts/fruits including but not limited to almond, argan, coconut, hazelnut, macadamia, pecan, pine, pistachio, and walnut; crushed or ground pits/kernels of fruits including but not limited to apricot, olive, peach, cherry, plum, palm, and tagua; crushed or ground corn cob, crushed or ground synthetic polymeric materials including but not limited to any thermoplastic polymer or any thermoset polymer; crushed, ground, or unmodified naturally-derived polymeric materials including but not limited to polyhydroxyalkanoates; precision-shaped synthetic polymeric materials; crushed or ground soft minerals including but not limited to calcium carbonate (marble, limestone, etc.), talc and related clay minerals, pumice, and gypsum and related minerals.

If the particle sizes are too large, the composite is more likely to cause inadvertent “wild” scratches on the surface being cleaned. If the particle sizes of the abrasive articles are too small, they may be ineffective at scouring. In one embodiment, the abrasive particles have an average particle size of between about 0.5 millimeters (mm) and about 2.0 mm, and particularly between about 1.0 mm and about 2.0 mm. In one embodiment, when abrasive particles are included in the composition, the composition includes between 3 wt. % and 8 wt. % abrasive particles, such as between 5 wt. % and 7 wt. % abrasive particles, based on a total weight of the compressed composition.

The composition has an acidic pH, making it favorable to cleaning surfaces, such as a toilet bowl, which are etched by protons in aqueous solution. In addition, hard water stains and lime scales can be dissolved under acidic conditions. A basic pH is favorable to forming hard water stains and deposits of organic matters on toilet bowl. Thus, it is desirable for the composition to have an acidic pH. In one embodiment, the composition has a pH of between about 0 and about 6, particularly between about 1 and about 5, and particularly between about 2 and about 5 when dissolved in water.

Due in part to its low pH, the composition can effectively remove various debris and stains, such as hard water stains and lime scale. In practice, the composition must come into contact with a sufficient amount of water or a mixture of water and polar solvents to begin the reactions needed to clean the intended surface. Once the composition is exposed to water, the composition will begin to dissolve and foam. Water serves as a media for reactions to take place. The acid and gas generator react to release carbon dioxide which rises to the surface through aqueous solution of surfactants, creating bubbles in solution and forming a foam layer on surface. The foaming allows the composition to contact hard to reach surfaces, such as the underside of the inner surface of a toilet bowl. In one embodiment, a sufficient amount of foam is produced to have a foam height of at least about 0.1 cm, at least about 0.5 cm, at least about 0.75 cm, at least about 1 cm, at least about 1.25 cm, at least about 1.5 cm, at least about 1.75 cm, at least about 2 cm, and at least about 3 cm.

The composition has two key characteristics: cleaning efficacy and the ability to be molded into various geometries under room temperature. The cleaning efficacy includes effervescence, foaming, acidity, and abrasive properties to remove hard water stain, limescale and organic stains from the surface to be cleaned. In one embodiment, the composition can be added into water wherein the cleaning efficacy is static without the use of mechanical force. In one embodiment, the composition can be used as a scrubber on a surface wherein the cleaning efficacy is a convolution of static cleaning efficacy and scrubbing by mechanical force. Additional features of the composition including fragrance, color, oxidizing power, and antimicrobial properties that can be incorporated into the basic formula of the composition to allow the creation of a wide spectrum of cleaning products. In one embodiment, the composition can remove at least about 25%, at least about 50%, at least about 60%, at least about 70%, at least about 80%, at least about 90%, at least about 95% of hard water stains. In one embodiment, the solid-state composition can remove at least about 25%, at least about 50%, at least about 60%, at least about 70%, at least about 80%, at least about 90%, at least about 95% of lime scale.

In some cases, after being molded into a condensed, solid-state format, the composition provides adequate mechanical integrity, hardness, toughness, and durability to be used on a hard surface. In one embodiment, the solid-state composition is in the form of a tablet or pod that can be dropped into, for example, a toilet bowl, to provide cleaning. In one embodiment, the composition can be molded into a cleaning head and used in conjunction with a handheld tool. This provides a dissolvable head that functions as a scrubbing tool as well as providing the needed chemicals for cleaning. The solid-state composition thus has dual functionality of being used as a tablet and/or used on a handle. The solid-state composition can also first be used on a handle for cleaning with mechanical force and then released into water for static cleaning.

Optionally, the composition has a certain hardness and durability such that it does not immediately dissolve or break apart when it is contacted with water and must remain in a solid-state form for an amount of time sufficient to contact and clean a surface. In one embodiment, the composition has an aged Shore A hardness of at least about 30, particularly at least about 30, more particularly at least about 50 and about 100, and even more particularly at least about 80. In one embodiment, the solid-state composition has an aged Shore D hardness of between about 10 and about 100, and particularly between about 20 and about 70.

The amount of time the composition remains in a solid-state form can be measured as dissolution time, defined as the time that a 5 gram solid-state composition takes to disintegrate and dissolve when immersed in 195 grams of water without agitation after the 5 gram solid-state composition has been aged in the air at ambient conditions for 2 weeks. The solid-state composition has a dissolution time that is optimal for scrubbing the surface to be cleaned. In one embodiment, the solid-state composition has a dissolution time of between about 1 minute and about 60 minutes, particularly between about 5 and about 40 minutes, and particularly between about 10 and about 30 minutes.

To make the solid-state composition of the present invention, the components are mixed together. If there is a fragrance, the composition must include an anti-caking agent. In one embodiment, the anti-caking agent is hydrophobic. Examples of suitable anti-caking agents include, but are not limited to: fumed silica, fumed alumina, clay, and corn starch. The anti-caking agent and fragrance are first mixed, and then mixed with any surfactants to form a pre-mixture, after which the pre-mixture is mixed with the mixture of remaining components. The final mixture of the composition is added into a cavity or mold where mechanical force is applied to compress the mixture into a compressed article. The compressed article can take on any geometry without departing from the intended scope of the present invention. After released from the cavity or mold, the compressed article is aged in the air or in a sealed environment at ambient conditions to allow it to harden over time. In one embodiment, the resulting solid-state composition is compressed to form a tablet. In one embodiment, the solid-state composition is wrapped by a water-soluble polymer film to form a pod.

### Solid Coating

Due to the presence of various components of the compressed composition that contribute to cleaning capability, the compressed composition tends to be sensitive to water (including humidity) and heat. It is thus challenging to successfully coat a molten material on the compressed composition and cool the coating, all without causing a significant amount of damage/degradation to the compressed composition.

The solid coating advantageously provides at least one active ingredient and has both the characteristics of being melt-processable and soluble in water. The solid coating comprises a polyethylene oxide (which is also known as polyethylene glycol) carrier. The term “polyethylene oxide carrier” encompasses polyethylene oxide (PEO) homopolymers, PEO copolymers that are greater than 50% by mass of PEO, and PEO derivatives. Each of the aforementioned PEO components may independently be linear or branched. Typically, the polyethylene oxide carrier has a molecular weight of 600 grams per mole (g/mol) or greater, 800 g/mol, 1000 g/mol, 2000 g/mol, 4000 g/mol, 6000 g/mol, 8000 g/mol, 10,000 g/mol, 16,000 g/mol, 20,000 g/mol, 50,000 g/mol, 80,000 g/mol, 100,000 g/mol, 160,000 g/mol, or 200,000 g/mol or greater; and 5,000,000 g/mol or less, 4,000,000 g/mol, 3,000,000 g/mol, 2,000,000 g/mol, 1,000,000 g/mol, 800,000 g/mol, 600,000 g/mol, 200,000 g/mol, 100,000 g/mol, 40,000 g/mol, or 20,000 g/mol or less.

Some suitable PEO homopolymers include for instance and without limitation, those commercially available under the trade designation “CARBOWAX” from Dow (Midland, MI), such as each of CARBOWAX Polyethylene Glycol 400 Polyethylene Glycol 1450, Polyethylene Glycol 6000, and Polyethylene Glycol 8000. In select embodiments, polyethylene oxide homopolymers having a molecular weight of 4000 to 8000, inclusive, may be particularly suitable due to having a convenient melting temperature between about 70° C. and 90° C. and tending to solidify well upon cooling. Some suitable PEO copolymers include for instance and without limitation, those commercially available under the trade designation “PLURONIC” from BASF (Ludwigshafen, Germany), such as Pluronic F127, a triblock copolymer of PEO100-PPO65-PEO100, with average molecular weight of 12600 g/mol.

Typically, the polyethylene oxide carrier is present in an amount of 30% by weight or more of a total weight of the solid coating, such as 40%, 45%, 50%, 55%, 60%, 65%, 70%, 75%, 80%, 85%, or 90% by weight or more of a total weight of the solid coating; and 99.5% by weight or less.

In some embodiments, at least one functional ingredient is selected from a fragrance, a dye, a surfactant, an antimicrobial agent, an emulsifier, a light stabilizer, an antioxidant, a pigment, an acid, a chelating agent, a polyelectrolyte, a silane, or any combination thereof. Suitable surfactants, acids, and chelating agents are as described above with respect to the compressed composition.

Some suitable light stabilizers include for instance and without limitation, those commercially available under the trade designation “TINUVIN” from BASF (Ludwigshafen, Germany), such as TINUVIN 1130 and TINUVIN 292. Some suitable antioxidants include for instance and without limitation, those commercially available under the trade designation “IRGANOX” from BASF (Ludwigshafen, Germany), such as IRGANOX 1076 and IRGANOX 245. Some suitable polyelectrolytes include for instance and without limitation, those commercially available under the trade designation “LUPASOL” and “SOKALAN” from BASF (Ludwigshafen, Germany), such as and Lupasol PS and Sokalan CP50. Some suitable silanes include for instance and without limitation, 3-[methoxy(polyethyleneoxy)6-9]propyltrimethoxysilane and 3-{[dimethyl(3-trimethoxysilyl)propyl]ammonio}propane-1-sulfonate from Gelest Inc (Morrisville, PA).

In some cases, the functional ingredient includes a microencapsulated fragrance. A shell of a microencapsulated fragrance tends to be too fragile to be suitably incorporated into a compressed composition, thus including a microencapsulated fragrance into the solid coating as a functional ingredient advantageously allows its use in a cleaning article that comprises a compressed composition. Microencapsulated fragrances are known in the art; one commercially available microencapsulated fragrance is available under the trade designation “Sozio Microcap 1323” microencapsulated fragrance from Sozio Inc., Piscataway, NJ.

### Methods

In a second aspect, a method of making a cleaning article is provided. The method comprises:
obtaining a molten mixture of a polyethylene oxide carrier and at least one functional ingredient;
applying the molten mixture to at least a portion of an exterior surface of a compressed composition; and
cooling the applied molten mixture to form a solid coating.

Each of the compressed composition and the solid coating are according to any embodiment of the first aspect described in detail above.

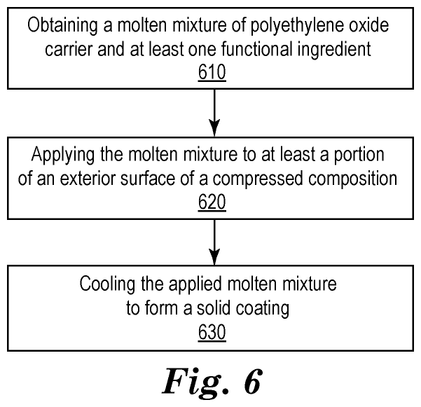

Referring to FIG. 6, the method comprises the steps of Obtaining a molten mixture of a polyethylene oxide carrier and at least one functional ingredient 610; Applying the molten mixture to at least a portion of an exterior surface of a compressed composition 620; and Cooling the applied molten mixture to form a solid coating 630.

In some embodiments, obtaining the molten mixture comprises mixing a solid polyethylene oxide carrier with at least one functional ingredient and applying heat at least until the solid polyethylene oxide carrier melts. In some embodiments, heat is applied to the solid polyethylene oxide carrier followed by adding at least one functional ingredient and mixing. If there are two or more functional ingredients, each functional ingredient can be independently added to the mixture before, during, or after melting the polyethylene oxide carrier.

The manner in which the molten mixture is applied to the at least a portion of an exterior surface of the compressed composition is not particularly limited. For instance, the molten mixture may comprise pouring, brushing, spray coating, dip coating, spin coating, roll coating, bar coating, curtain coating, rotogravure coating, knife coating, slide coating, inkjet printing, or any combination thereof.

When the molten mixture is applied to the compressed composition, the molten mixture may have a temperature of 60° C. or greater, 65° C., 70° C., 75° C., 80° C., 85° C., 90° C., or 95° C. or greater; and 200° C. or less, 190° C., 180° C., 170° C., 160° C., 150° C., 140° C., 130° C., 120° C., 110° C., or 100° C. or less. Stated a different way, in some embodiments the molten mixture has a temperature of 60° C. to 200° C., 70° C. to 130° C., or 90° C. to 110° C., at the time of application to the compressed composition.

The manner in which the molten mixture is cooled is not particularly limited. For instance, the cooling may comprise exposing the applied molten mixture to flowing air, exposing the molten mixture to ambient air, exposing the molten mixture to refrigerated air, or any combination thereof. Refrigerated air has a temperature below ambient, e.g., 19° C. or less, 17° C., 15° C., 13° C., 11° C., 9° C., 8° C., 7° C., 6° C., 5° C., 4° C., 3° C., 2° C., 1° C., or 0° C. or less; and −10° C. or greater. In cases in which the molten mixture is applied at a higher temperature, it may be advantageous to expose the applied molten mixture to flowing air and/or refrigerated air to more rapidly solidify the molten mixture to minimize heat damage occurring to the compressed composition.

### Kits

In a third aspect, a kit is provided. The kit comprises:
a cleaning article according to any embodiment of the first aspect; and
a tool configured to attach to the cleaning article.

In some cases, the tool is a handheld tool configured to grip an exterior surface of the cleaning article. Referring to FIG. 7A, a kit 760 is depicted including a cleaning article 700 and a handheld tool 770 that is gripping an exterior surface of the cleaning article 700. In particular, an end 772 of the handheld tool is inserted into a cavity 750 of the cleaning article 700. Additionally, FIG. 7A provides an illustration of the kit in use. A user 790 is gripping an opposing end 774 of the handheld tool 770 and the cleaning article 700 is positioned against an interior bowl surface 782 of a toilet 780. The user 790 has the option of manipulating the handheld tool 770 to apply pressure and/or scrubbing of the cleaning article 700 in the toilet 780. Also depicted is some dissolved cleaning article 752 in the toilet 780.

In some cases, the cleaning article can be used without also using the handheld tool. For example, FIG. 7B provides an illustration of a user 790 dropping a cleaning article 700 into a toilet 780, where it can dissolve and release cleaning agents.

### EMBODIMENTS

In a first embodiment, the present disclosure provides a cleaning article. The cleaning article comprises a compressed composition comprising an exterior surface; and a solid coating disposed on at least a portion of the exterior surface of the compressed composition. The compressed composition comprises a gas generator, an acid, a surfactant, and a binder. The solid coating comprises a polyethylene oxide carrier and at least one functional ingredient.

In a second embodiment, the present disclosure provides a cleaning article according to the first embodiment, wherein the compressed composition is in a form of a tablet having a first major surface and a second major surface, and wherein a portion of the second major surface defines a cavity in the tablet.

In a third embodiment, the present disclosure provides a cleaning article according to first embodiment or the second embodiment, wherein the polyethylene oxide carrier has a molecular weight of 600 to 5,000,000 grams per mole.

In a fourth embodiment, the present disclosure provides a cleaning article according to any of the first through third embodiments, wherein the polyethylene oxide carrier is present in an amount of 30% by weight or more of a total weight of the solid coating, 40%, 50%, 60%, 70%, 80%, or 90% by weight or more of a total weight of the solid coating.

In a fifth embodiment, the present disclosure provides a cleaning article according to any of the first through fourth embodiments, wherein the at least one functional ingredient is selected from a fragrance, a dye, a surfactant, an antimicrobial agent, an emulsifier, a light stabilizer, an antioxidant, a pigment, an acid, a chelating agent, a polyelectrolyte, a silane, or any combination thereof.

In a sixth embodiment, the present disclosure provides a cleaning article according to the fifth embodiment, wherein the at least functional ingredient comprises a microencapsulated fragrance.

In a seventh embodiment, the present disclosure provides a cleaning article according to any of the first through sixth embodiments, wherein the compressed composition further comprises a plurality of abrasive particles.

In an eighth embodiment, the present disclosure provides a cleaning article according to any of the first through seventh embodiments, wherein the binder comprises at least one of calcium sulfate hemihydrate, anhydrous calcium sulfate, sodium silicate, sodium metasilicate, potassium silicate, potassium metasilicate, lithium metasilicate, lithium silicate, or cement.

In a ninth embodiment, the present disclosure provides a cleaning article according to any of the first through eighth embodiments, wherein the gas generator comprises at least one of sodium carbonate, sodium bicarbonate, potassium carbonate, potassium bicarbonate, magnesium carbonate, hydrogen peroxide, peracetic acid, or a percarbonate salt.

In a tenth embodiment, the present disclosure provides a cleaning article according to any of the first through ninth embodiments, wherein the acid comprises at least one of sodium bisulfate, sulfamic acid, glycolic acid, maleic acid, benzoic acid, or succinic acid.

In an eleventh embodiment, the present disclosure provides a method of making a cleaning article. The method comprises: obtaining a molten mixture of a polyethylene oxide carrier and at least one functional ingredient; applying the molten mixture to at least a portion of an exterior surface of a compressed composition; and cooling the applied molten mixture to form a solid coating.

In a twelfth embodiment, the present disclosure provides a method according to the eleventh embodiment, wherein the obtaining the molten mixture comprises mixing a solid polyethylene oxide carrier with the at least one functional ingredient and applying heat at least until the solid polyethylene oxide carrier melts.

In a thirteenth embodiment, the present disclosure provides a method according to the eleventh embodiment or the twelfth embodiment, wherein the applying the molten mixture comprises pouring, brushing, spray coating, dip coating, spin coating, roll coating, bar coating, curtain coating, rotogravure coating, knife coating, slide coating, inkjet printing, or any combination thereof.

In a fourteenth embodiment, the present disclosure provides a method according to any of the eleventh through thirteenth embodiments, wherein when the molten mixture is applied to the compressed composition, the molten mixture has a temperature of 60° C. to 200° C., 70° C. to 130° C., or 90° C. to 110° C.

In a fifteenth embodiment, the present disclosure provides a method according to any of the eleventh through fourteenth embodiments, wherein the cooling comprises exposing the applied molten mixture to flowing air.

In a sixteenth embodiment, the present disclosure provides a method according to any of the eleventh through fifteenth embodiments, wherein the compressed composition and the solid coating are according to any of the first through tenth embodiments.

In a seventeenth embodiment, the present disclosure provides a kit. The kit comprises: the cleaning article according to any of the first through tenth embodiments; and a tool configured to attach to the cleaning article.

In an eighteenth embodiment, the present disclosure provides a kit according to the seventeenth embodiment, wherein the tool is a handheld tool configured to grip an exterior surface of the cleaning article.

### EXAMPLES

Unless otherwise noted or apparent from the context, all parts, percentages, ratios, etc. in the Examples and the rest of the specification are by weight. Table 1, below, lists materials used in the examples and their sources.

TABLE 1
Table of materials, abbreviations, and sources.

| Material | Description |
|---|---|
| Sodium carbonate | Obtained from Genesis Alkali, Green River, WY |
| Citric acid | Granular grade, obtained from Cargill, Wayzata, MN |
| Sulfamic acid | Coarse grade, obtained from Univar Solutions Inc., Downers Grove, IL |
| Lathonal LAL | Anionic surfactant providing foaming, wetting and emulsification, |
| | obtained from Stepan Company, Northfield, IL |
| Stepanol WA-100 NF/USP | Anionic surfactant used in dentifrices, hand cleaners, bubble baths, liquid |
| | hand soaps and shampoo formulations, obtained from Stepan Company |
| Sipernat 50S | Silica with high absorption capacity, obtained from Evonik Industries |
| | AG, Essen, Germany |
| Calcium Sulfate Hemihydrate | Active ingredient of DuraBond 45 Joint Compound, Sheetrock brand, |
| | one-day drywall finishing and next-day decoration of drywall interiors |
| | and exterior soffits, obtained from The Home Depot, Inc., Atlanta, GA |
| Sokalan CP10 | Modified polyacrylic acid sodium salt, 45% solids aqueous solution, |
| | weight average molecular weight (Mw) is ~3500, obtained from BASF, |
| | Ludwigshafen, Germany |
| SZ 41894 Citrus | Fragrance, obtained from Sozio Inc., Piscataway, NJ |
| Duasyn Ink Blue SLK | Dye, obtained from Clariant AG, Muttenz, Switzerland |
| Pumice (FFF) | Fine grade, obtained from CB Minerals LLC, Mamaroneck, NY |
| PEG 1450 (CARBOWAX | Polyethylene glycol, range of average molecular weight |
| Polyethylene Glycol 1450 | 1305-1595, obtained from The Dow Chemical Company, Midland, MI |
| Flake) | |
| PEG 400 (CARBOWAX | Polyethylene glycol, range of average molecular weight 380-420, |
| Polyethylene Glycol 400) | obtained from The Dow Chemical Company |
| PEG 6000 (CARBOWAX | Polyethylene glycol, range of average molecular weight 5000-7000, flake |
| Polyethylene Glycol 6000) | form, ground into fine powder, obtained from The Dow Chemical |
| | Company |
| PEG 8000 (CARBOWAX | Polyethylene glycol, range of average molecular weight 7000-9000, |
| Polyethylene Glycol 8000) | obtained from The Dow Chemical Company |
| Thymol | ≥98.5% purity, obtained from Sigma Aldrich, St. Louis, MO |
| Rhodamine B | Dye, obtained from Sigma Aldrich |
| Capmul 908P | Propylene glycol monocaprylate, obtained from Abitec, Columbus, OH |
| Sozio Microcap 1323 | Microencapsulated fragrance, obtained from Sozio Inc. |

### Example 1

The composition of the compressed composition (e.g., tablet) described below is shown in Table 2. First, 44.7 g of calcium sulfate hemihydrate was mixed with 7.6 g of Sipernat 50S, followed by adding 22.3 g of Sokalan CP10. The mixture was mixed on a Ross mixer for 1 minute. Next, 97.4 of sodium carbonate, 12.5 g of citric acid, and 232.8 g of sulfamic acid were added one at a time, followed by mixing for 30 seconds. Lastly, 9.4 g of Lathanol LAL, 5.4 g of Stepanol WA-100 NF/USP, 8.9 g of pumice, and 8.9 g of magnesium stearate were added one at a time, followed by mixing for 30 seconds. The temperature in the chamber was at around 22° C. throughout the mixing process.

The prepared mixture was added into a Teflon mold and about 1134 kg weight was applied using a Carver hydraulic press. The mixture was allowed to dwell in the mold for 1 minute before pressure was released. The compressed composition had a disc shape, was 43 mm in diameter, and weighed about 24 g.

To make the coating formula, 5.0 g of PEG 1450, 0.5 g of Lathanol LAL, 0.3 g of Stepanol WA-100 NF/USP, 0.1 g of SZ 41894 Citrus, and 0.02 g of Duasyn Ink Blue SLK were added to an aluminum weighing dish, then heated in an oven set at 120° C. until it formed a molten mixture. The curved surface of a compressed composition was wrapped by tape to create a reservoir extending above a top surface of the compressed composition (i.e., the tape was wrapped around the edge to form a cylindrical shape). The molten mixture was poured into the reservoir and allowed to cool to room temperature to solidify. Referring again to FIG. 2A, a photograph of the resulting cleaning article 200 is shown, including the solid coating 220 on a major exterior surface 212 of the compressed composition 210.

The coating composition described above is shown in Table 3.

TABLE 2
Compressed Composition in Example 1 (EX 1)

| Ingredient | Weight (%) | Weight (g) |
|---|---|---|
| Sodium Carbonate | 21.6% | 97.4 |
| Citric Acid | 2.8% | 12.5 |
| Sulfamic Acid | 51.7% | 232.8 |
| Lathanol LAL | 2.1% | 9.4 |
| Stepanol WA-100 NF/USP | 1.2% | 5.4 |
| Sipernat 50S | 1.7% | 7.6 |
| Calcium Sulfate Hemihydrate | 9.9% | 44.7 |
| Sokalan CP10 | 5.0% | 22.3 |
| Pumice (FFF) | 2.0% | 8.9 |
| Magnesium Stearate | 2.0% | 8.9 |
| Total | 100.0% | 450.0 |

TABLE 3
Coating Composition in EX 1

| Ingredient | Weight (%) | Weight (g) |
|---|---|---|
| PEG 1450 | 84.5% | 5.0 |
| Lathanol LAL | 8.4% | 0.5 |
| Stepanol WA-100 NF/USP | 5.1% | 0.3 |
| SZ 41894 Citrus | 1.7% | 0.1 |
| Duasyn Ink Blue SLK | 0.3% | 0.02 |
| Total | 100.0% | 5.92 |

### Example 2

The compressed composition used in Example 2 (EX 2) was made using the procedure described in Example 1 and the composition in Table 2.

To make the coating formula, 4.5 g of PEG 1450 was added to an aluminum weighing dish, heated in an oven set at 100° C. until molten. Next, 0.01 g of Rhodamine B and 0.50 g of Capmul 908P were added, and the resulting mixture was heated in an oven set at 100° C. The temperature of the oven was reduced to 95° C. and the tablet was dipped coated in the molten mixture. The coating weight applied on tablet surface was 4.76 g. The coated tablet weighed 28.80 g. The Capmul 908P loading in the coated tablet was 1.65%, calculated as follows: ((4.76 g×0.1)/(4.76 g of coating+24.04 g of bare tablet))×100. The coating composition described above is shown in Table 4.

TABLE 4
Coating Composition in EX 2

| Ingredient | Weight (%) | Weight (g) |
|---|---|---|
| PEG 1450 | 89.8% | 4.5 |
| Rhodamine B | 0.2% | 0.01 |
| Capmul 908P | 10.0% | 0.50 |
| Total Weight | 100.0% | 5.01 |

### Example 3

The compressed composition used in Example 3 (EX 3) had the geometry illustrated in FIG. 3. More particularly, the compressed composition 310 had an outer diameter of 51 mm, a cavity 350 diameter of 30.94 mm, a total height H of 20.2 mm, and a thickness between a first major surface 312 and a cavity surface 316 of 7.15 mm. The compressed composition was made using the procedure described in Example 1, had the composition described in Table 5, and weighed about 53 g.

To make the coating formula, 4.0 g of PEG 1450 and 1.0 g of Thymol were added to an aluminum weighing dish, heated in an oven set at 110° C. until it formed a molten mixture. Next, 0.005 g of Duasyn Ink Blue SLK was added, and the resulting mixture was heated in an oven set at 110° C. until it formed a molten mixture. The temperature of the oven was reduced to 95° C. and the molten mixture was applied on the bottom dome surface and the top rim of the tablet. The total coating weight was about 4.3 g. The coating composition described above is shown in Table 6.

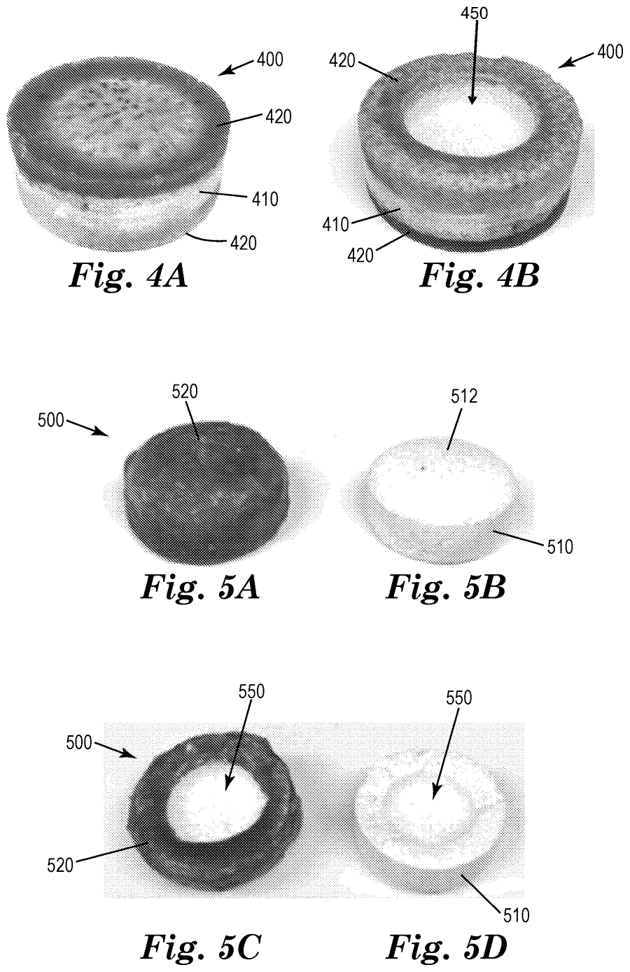

The curved surface of the compressed composition was wrapped by tape to create a reservoir. The molten mixture was poured into the reservoir and allowed to cool to room temperature to solidify. The rim of the cavity side was dip coated in the molten formulation. Referring to FIGS. 4A-4B, photographs are provided of the cleaning article 400 of Example 4, including the compressed composition 410 having solid coating 420 on both the continuous major exterior surface and the edge defining the top of the cavity 450.

TABLE 5
Composition of Tablet in EX 3

| Ingredient | Weight (%) |
|---|---|
| PEG 400 | 0.3 |
| Duasyn Ink Blue SLK | 0.01 |
| Sodium carbonate | 23.0 |
| SZ 41894 Citrus | 0.3 |
| Sokalan CP10 | 1.5 |
| Stepanol WA-100 NF/USP | 1.5 |
| Lathanol LAL | 2.5 |
| Sipernat 50S | 0.5 |
| Calcium sulfate hemihydrate | 10.0 |
| Citric acid | 10.4 |
| Sulfamic acid | 50.0 |
| Total | 100.01 |

TABLE 6
Coating Composition in EX 3

| Ingredient | Weight (%) | Weight (g) |
|---|---|---|
| PEG 1450 | 79.9% | 4.00 |
| Thymol | 20.0% | 1.00 |
| Duasyn Ink Blue SLK | 0.1% | 0.005 |
| Total Weight | 100.0% | 5.01 |

### Example 4

The compressed composition used in Example 4 (EX 4) was a scaled-down version of the tablet in FIG. 3. The compressed composition was made using the procedure described in Example 1, had the composition described in Table 7, and had an outer diameter of 20 mm.

To make the coating formula, 4.1 g of PEG 1450 and 0.013 g of Duasyn Ink Blue SLK were added to an aluminum weighing dish and heated in an oven set at 95° C. until it formed a molten mixture. Next, 0.41 g of Sozio Microcap 1323 was added, and the resulting mixture was kept in the oven set at 95° C. until it formed a molten mixture. The molten mixture was applied on the continuous major exterior surface, side surfaces, and top rim of the compressed composition. The total coating weight was 0.94 g. The coating composition described above is shown in Table 8. FIGS. 5A and 5C show photographs of the cleaning article 500, including the solid coating 520 on the surfaces as just described, but not on the cavity 550.

FIGS. 5B and 5D show photographs of the compressed composition 510 prior to coating. FIG. 5B shows the continuous major exterior surface 512 and FIG. 5B shows the cavity 550 in the compressed composition 510. To test the foaming kinetics, both the uncoated compressed composition (3.38 g), and the cleaning article (3.25 g before coating, 4.19 g after coating) were dropped into 150 mL tap water in a 500 ml beaker. Foaming height was measured as a function of time. The cleaning article gives slower and more stable effervescence than the compressed composition. PEG is known to act as a defoamer, yet the cleaning article does still provide foam. The results are shown in Table 9. The cleaning article contained significantly higher concentration of dye (0.3 wt. % after coating vs 0.01 wt. % before coating), leading to a dark blue color after it was dissolved in water.

TABLE 7
Composition of Compressed in EX 4

| | Weight |
|---|---|
| Ingredient | (%) |
| Duasyn Ink Blue SLK | 0.01 |
| Sodium carbonate | 23 |
| Citrus Cleanscent Fragrance | 0.3 |
| Stepanol WA-100 NF/USP | 1.5 |
| Lathonal LAL | 2.5 |
| Silicon Dioxide, Chemically Prepared | 0.5 |
| Calcium sulfate hemihydrate | 5 |
| Citric acid | 7.36 |
| Sulfamic acid | 49.83 |
| PEG 6000 | 10 |
| Total | 100 |

TABLE 8
Coating Composition in EX 4

| Ingredient | Weight (%) | Weight (g) |
|---|---|---|
| PEG 1450 | 90.5% | 4.1 |
| Sozio Microcap 1323 | 9.2% | 0.41 |
| Duasyn Ink Blue SLK | 0.3% | 0.013 |
| Total Weight | 100.0% | 4.47 |

TABLE 9
Foaming Kinetics before and after Coating in EX 4

Foam Height (mm)

| Time | Compressed | Cleaning |
|---|---|---|
| (min) | Composition | Article |
| 0 | 0 | 0 |
| 1 | 2 | 2 |
| 2 | 4 | 3 |
| 3 | 8 | 4 |
| 4 | 7 | 5 |
| 5 | 5 | 5 |
| 6 | 5 | 5 |
| 7 | 4 | 4 |

Although the present invention has been described with reference to preferred embodiments, workers skilled in the art will recognize that changes may be made in form and detail without departing from the spirit and scope of the invention.

1. A cleaning article comprising:
a compressed composition comprising an exterior surface, the compressed composition comprising a gas generator, an acid, a surfactant, and a binder; and
a solid coating disposed on at least a portion of the exterior surface of the compressed composition, the solid coating comprising a polyethylene oxide carrier and at least one functional ingredient.

2. The cleaning article of claim 1, wherein the compressed composition is in a form of a tablet having a first major surface and a second major surface, and wherein a portion of the second major surface defines a cavity in the tablet.

3. The cleaning article of claim 1, wherein the polyethylene oxide carrier has a molecular weight of 600 to 5,000,000 grams per mole.

4. The cleaning article of claim 1, wherein the polyethylene oxide carrier is present in an amount of 30% by weight or more of a total weight of the solid coating, 40%, 50%, 60%, 70%, 80%, or 90% by weight or more of a total weight of the solid coating.

5. The cleaning article of claim 1, wherein the at least one functional ingredient is selected from a fragrance, a dye, a surfactant, an antimicrobial agent, an emulsifier, a light stabilizer, an antioxidant, a pigment, an acid, a chelating agent, a polyelectrolyte, a silane, or any combination thereof.

6. The cleaning article of claim 5, wherein the at least functional ingredient comprises a microencapsulated fragrance.

7. The cleaning article of claim 1, wherein the compressed composition further comprises a plurality of abrasive particles.

8. The cleaning article of claim 1, wherein the binder comprises at least one of calcium sulfate hemihydrate, anhydrous calcium sulfate, sodium silicate, sodium metasilicate, potassium silicate, potassium metasilicate, lithium metasilicate, lithium silicate, or cement.

9. The cleaning article of claim 1, wherein the gas generator comprises at least one of sodium carbonate, sodium bicarbonate, potassium carbonate, potassium bicarbonate, magnesium carbonate, hydrogen peroxide, peracetic acid, or a percarbonate salt.

10. The cleaning article of claim 1, wherein the acid comprises at least one of sodium bisulfate, sulfamic acid, glycolic acid, maleic acid, benzoic acid, or succinic acid.

11. A method of making a cleaning article, the method comprising:
obtaining a molten mixture of a polyethylene oxide carrier and at least one functional ingredient;
applying the molten mixture to at least a portion of an exterior surface of a compressed composition; and
cooling the applied molten mixture to form a solid coating.

12. The method of claim 11, wherein the obtaining the molten mixture comprises mixing a solid polyethylene oxide carrier with the at least one functional ingredient and applying heat at least until the solid polyethylene oxide carrier melts.

13. The method of claim 11, wherein the applying the molten mixture comprises pouring, brushing, spray coating, dip coating, spin coating, roll coating, bar coating, curtain coating, rotogravure coating, knife coating, slide coating, inkjet printing, or any combination thereof.

14. The method of claim 11, wherein when the molten mixture is applied to the compressed composition, the molten mixture has a temperature of 60° C. to 200° C., 70° C. to 130° C., or 90° C. to 110° C.

15. The method of claim 11, wherein the cooling comprises exposing the applied molten mixture to flowing air.

16. The method of claim 11, wherein the compressed composition and the solid coating are according to claim 1.

17. A kit comprising:
the cleaning article of claim 1; and
a tool configured to attach to the cleaning article.

18. The kit of claim 17, wherein the tool is a handheld tool configured to grip an exterior surface of the cleaning article.
